(19) United States
(12) Patent Application Publication
(10) Pub. No.: US 2012/0093514 A1
(43) Pub. Date: Apr. 19, 2012

(54) BI-DIRECTIONAL CWDM (OR DWDM) TRANSMISSION SYSTEM USING SINGLE WAVELENGTH BI-DIRECTIONAL TRANSCEIVERS

(76) Inventors: Kwang Soo Park, Tinton Falls, NJ (US); Won Ki Lee, Seoul (KR); Moon Soo Park, Gwangju (KR); Yong Kwan Park, Annandale, NJ (US)

(21) Appl. No.: 12/907,920

(22) Filed: Oct. 19, 2010

(51) Int. Cl. H04J 14/02

(52) U.S. Cl. 398/79

(57) ABSTRACT

The present invention provides a bi-directional CWDM (or DWDM) transmission system using SWBiDi transceivers for a continuous and simultaneous communication in both directions comprising an optical link fiber, first n CWDM (or DWDM) SWBiDi transceivers at a first end of the optical link fiber, second n CWDM (or DWDM) SWBiDi transceivers at a second end of the optical link fiber, a first optical CWDM (or DWDM) MUX/DEMUX between first n CWDM (or DWDM) SWBiDi transceivers and the optical link fiber, and a second optical CWDM (or DWDM) MUX/DEMUX between second n DWDM SWBiDi transceivers and the optical link fiber.

### BACKGROUND OF INVENTION

1. Field of the Invention

The invention relates to a WDM (wavelength division multiplexing) optical fiber transmission system, and more particulary, to a bi-directional CWDM (coarse WDM) or DWDM (dense WDM) transmission system using single wavelength bi-directional (SWBiDi) transceivers within such transmission system. The applications of the present invention include systems, for example, such as in access networks of FTTx and in wireless backhauls between a base station and an antenna tower or a remote radio head (RRH), but not limited only to these systems. A SWBiDi transceiver is a transceiver a pair of which can communicate with each other continuously and simultaneously in both directions using one wavelength over a single optical link fiber.

2. Description of the Related Art.

Typical WDM transmission systems currently in use are unidirectional. Therefore a pair of fibers and two sets of pair of MUX and DEMUX shown in FIG. 1 are needed for a continuous and simultaneous communication of all WDM channels in both directions, one for one direction and the other for the opposite direction. This technology offers a continuous and simultaneous communication in both directions, but needs two pairs of optical MUX/DEMUX's and two optical link fibers which cost network operators more than when one optical link fiber is used.

A bi-directional WDM transmission system using two-wavelength, bi-directional transceivers use one optical link fiber for a communication of all WDM channels in both directions. However, each channel can transmit a signal in a designated direction only during an allotted time slot using a TDM scheme while it can transmit a signal continuously in the opposite direction. This is because all WDM channels must share the carrier wavelength in a designated direction. Therefore a continuous and simultaneous communication of all WDM channels in both directions is not permitted.

An explosive increase of demand of bandwidth in the transmission of voice, data, and video has been exhausting in a fast rate optical fibers deployed in the field. At the same time, deploying new optical fibers to meet this demand is costly and puts huge financial burdens on Network operators which are trying to save as much money as they can in new capital investment. This necessitates a new, novel approach to solve these apparently conflicting goals.

### SUMMARY OF THE INVENTION

According to embodiments of the present invention, a bi-directional CWDM (or DWDM) transmission system using SWBiDi transceivers for a continuous and simultaneous communication in both directions may comprise a optical link fiber, first n CWDM (or DWDM) SWBiDi transceivers at a first end of the optical link fiber, second n CWDM (or DWDM) SWBiDi transceivers at a second end of the optical link fiber, a first optical CWDM (or DWDM) MUX/DEMUX between first n CWDM (or DWDM) SWBiDi transceivers and the optical link fiber, and a second optical CWDM (or DWDM) MUX/DEMUX between second n CWDM (or DWDM) SWBiDi transceivers and the optical link fiber.

According to embodiments of the present invention, a bi-directional CWDM (or DWDM) transmission system using SWBiDi transceivers may include a single fiber as an optical link fiber for a continuous and simultaneous communication of all WDM channels in both directions, which saves one optical link fiber while the need of the continuous and simultaneous communication of all WDM channels in both directions is met.

According to embodiments of the present invention, a bi-directional CWDM (or DWDM) transmission system using SWBiDi transceivers may include CWDM (or DWDM) SWBiDi transceivers and an optical MUX/DEMUX on a first end of the optical link fiber. The number of SWBiDi transceivers and the type of the optical MUX/DEMUX depend on the user's system requirement.

According to embodiments of the present invention, a bi-directional CWDM (or DWDM) transmission system using SWBiDi transceivers may include an optical MUX/DEMUX and CWDM (or DWDM) SWBiDi transceivers on a second end of the optical link fiber. The number of SWBiDi transceivers and the type of the optical MUX/DEMUX are same as those on the first end of the optical link.

### BRIEF DESCRIPTION OF THE DRAWINGS

FIG. 1 shows a conventional CWDM (or DWDM) transmission system using two optical link fibers and duplex transceivers for a continuous, simultaneous communication of all WDM channels in both directions.

FIG. 2 shows a bi-directional CWDM (or DWDM) transmission system using a single optical link fiber and SWBiDi transceivers for a continuous and simultaneous communication of all WDM channels in both directions according to embodiments of the present invention.

### DETAILED DESCRIPTION OF THE INVENTION

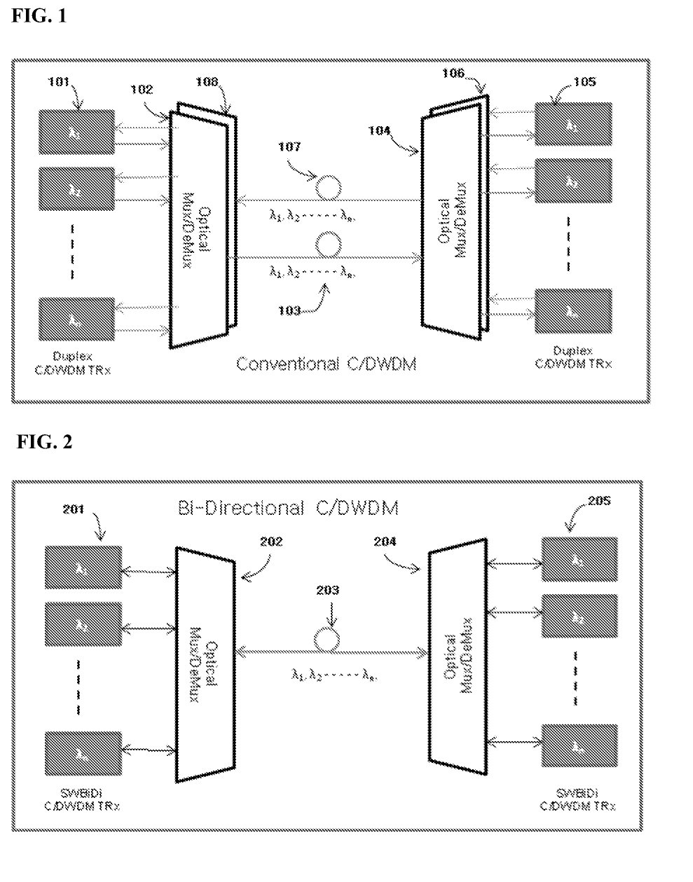

As shown in FIG. 1, a conventional CWDM (or DWDM) transmission system using duplex transceivers for a continuous and simultaneous communication in both directions includes n duplex C/DWDM transceivers 101, two optical MUX/DEMUXs 102 and 108, two optical link fibers 103 and 107, two optical MUX/DEMUXs 104 and 106, and n duplex C/DWDM transceivers 105. There are also n optical fiber jumpers between n transceivers and each optical MUX/DEMUX.

For the transmission from the first (or left) end to the second (or right) end, the transmitter of each transceiver 101 sends a signal at a specific wavelength, for example, the top transceiver at λ₁, the next transceiver at λ₂, . . . , and the bottom transceiver at λₙ. All of these signals are multiplexed at the optical MUX/DEMUX 102. The multiplexed signals are transmitted through the optical link fiber 103, and de-multiplexed at the optical MUX/DEMUX 104 into signals at λ₁, λ₂, . . . , and λₙ. Each of these de-multiplexed signals is received at the receiver of the specified transceiver 105, for example, the top transceiver at λ₁, the next transceiver at λ₂, . . . , and the bottom transceiver at λₙ.

For the transmission from the second (or right) end to the first (or left) end, the transmitter of each transceiver 105 sends a signal at a specific wavelength, for example, the top transceiver at λ₁, the next transceiver at λ₂, . . . , and the bottom transceiver at λₙ. All of these signals are multiplexed at the optical MUX/DEMUX 106. The multiplexed signals are transmitted through the optical link fiber 107, and de-multiplexed at the optical MUX/DEMUX 108 into signals at λ₁, λ₂, . . . , and λₙ. Each of these de-multiplexed signals is received at the receiver of the specified transceiver 101, for example, the top transceiver at λ₁, the next transceiver at λ₂, . . . , and the bottom transceiver at λₙ.

As explained above, the conventional CWDM (or DWDM) transmission system using duplex transceivers requires two pairs of optical MUX/DEMUXs, one pair (one of the pair dedicated for multiplexing outbound signals and the other of the same pair dedicated for de-multiplexing inbound signals) at each end of the transmission system, and a pair of optical link fibers between both ends, one dedicated for the transmission from the first end to the second end and the other dedicated for the transmission from the second end to the first end. In addition to these, there are 4*n optical fiber jumpers in total for this system.

According to embodiments of the present invention, a bi-directional CWDM (or DWDM) transmission system using SWBiDi transceivers for a continuous and simultaneous communication in both directions consists of n SWBiDi transceivers 201, one optical MUX/DEMUX 202, one optical link fiber 203, one optical MUX/DEMUX 204, and n SWBiDi transceivers 205 as shown in FIG. 2. There are also n optical fiber jumpers between n transceivers and each optical MUX/DEMUX and 2*n optical fiber jumpers in total for this system.

For the transmission from the first (or left) end to the second (or right) end, the transmitter of each transceiver 201 sends a signal at a specific wavelength, for example, the top transceiver at λ₁, the next transceiver at λ₂, . . . , and the bottom transceiver at λₙ. All of these signals are multiplexed at the optical MUX/DEMUX 202. The multiplexed signals are transmitted through the optical link fiber 203, and de-multiplexed at the optical MUX/DEMUX 204 into signals at λ₁, λ₂, . . . , and λₙ. Each of these de-multiplexed signals is received at the receiver of the specified transceiver of 205, for example, the top transceiver at λ₁, the next transceiver at λ₂, . . . , and the bottom transceiver at λₙ.

For the transmission from the second (or right) end to the first (or left) end, the transmitter of each transceiver 205 sends a signal at a specific wavelength, for example, the top transceiver at λ₁, the next transceiver at λ₂, . . . , and the bottom transceiver at λₙ. All of these signals are multiplexed at the optical MUX/DEMUX 204. The multiplexed signals are transmitted through the optical link fiber 203, and de-multiplexed at the optical MUX/DEMUX 202 into signals at λ₁, λ₂, . . . , and λₙ. Each of these de-multiplexed signals is received at the receiver of the specified transceiver 201, for example, the top transceiver at λ₁, the next transceiver at λ₂, . . . , and the bottom transceiver at λₙ.

It is apparent from the above description for a continuous and simultaneous communication in both directions that the bi-directional CWDM (or DWDM) transmission system using SWBiDi transceivers according to embodiments of the present invention offers a distinctive advantage over the conventional CWDM (or DWDM) transmission system using duplex transceivers. That is: the number of equipments between transceivers at both ends for the bi-directional CWDM (or DWDM) transmission system using SWBiDi transceivers according to embodiments of the present invention is only one half of that for the conventional CWDM (or DWDM) transmission system using duplex transceivers. This saves communication service providers/operators significantly in the capital expenditures, the operational expenditures, and the space needed for the fibers and the equipments, in addition to the complexity of management of a huge number of fibers.

The present invention can be applied to both of symmetric bi-directional WDM transmission system and asymetric bi-directional WDM transmission system. The term, “symetric” may indicate that the data rate of transmission of each channel in one direction is the same as that in the opposite direction, and the term, “asymmetric” may indicate that the data rate of transmission of each channel in one direction is different from that in the opposite direction.

While the said invention has been described herein with reference to a particular embodiment, it is understood that the invention is not limited thereto. The teachings of this invention may be utilized by one having ordinary skill in the art to make modifications within the scope thereof. For example, the invention is not limited to the particular type of optical WDM methods, SWBiDi transceivers, and optical MUX/DEMUX's.

What is claimed is:

1. A bi-directional CWDM transmission system using SWBiDi transceivers for a continuous and simultaneous communication in both directions comprising; anoptical link fiber, first n CWDM SWBiDi transceivers at a first end of the optical link fiber, second n CWDM SWBiDi transceivers at a second end of the optical link fiber, a first optical CWDM MUX/DEMUX between first n CWDM SWBiDi transceivers and the optical link fiber, and a second optical CWDM MUX/DEMUX between second n CWDM SWBiDi transceivers and the optical link fiber.

2. A bi-directional DWDM transmission system using SWBiDi transceivers for a continuous and simultaneous communication in both directions comprising; an optical link fiber, first n DWDM SWBiDi transceivers at a first end of the optical link fiber, second n DWDM SWBiDi transceivers at a second end of the optical link fiber, a first optical DWDM MUX/DEMUX between first n DWDM SWBiDi transceivers and the optical link fiber, and a second optical DWDM MUX/DEMUX between second n DWDM SWBiDi transceivers and the optical link fiber.

3. A bi-directional WDM transmission system using SWBiDi transceivers for a continuous and simultaneous communication in both directions comprising; an optical link fiber, first n WDM SWBiDi transceivers at a first end of the optical link fiber, second n WDM SWBiDi transceivers at a second end of the optical link fiber, a first optical WDM MUX/DEMUX between first n WDM SWBiDi transceivers and the optical link fiber, and a second optical WDM MUX/DEMUX between second n WDM SWBiDi transceivers and the optical link fiber, where in the number of the SWBiDi transceivers, n, is no less than 2.
